(19) United States
(12) Patent Application Publication
(10) Pub. No.: US 2008/0056804 A1
(43) Pub. Date: Mar. 6, 2008

(54) Cosmetic Vessel Having Exchangeable Touch Part

(76) Inventor: Ho Suk Song, Incheon (KR)

Correspondence Address: PARK LAW FIRM, 3255 WILSHIRE BLVD, SUITE 1110, LOS ANGELES, CA, 90010, US

(21) Appl. No.: 11/843,544

(22) Filed: Aug. 22, 2007

(30) Foreign Application Priority Data
Aug. 29, 2006 (KR) 10-2006-0082420

(51) Int. Cl. A46B 11/00; B43K 29/00

(52) U.S. Cl. 401/129; 401/118; 401/126; 401/195

(57) ABSTRACT

Provided is a cosmetic vessel having an exchangeable touch part includes an accommodating part having an opening formed at one side thereof and containing liquid content; a discharge part coupled with an opening of the accommodating part and having at least one discharge projection formed at its one side to discharge the content therethrough; a touch part having a through-hole through which the discharge projection of the discharge part is inserted; and a cover part surrounding the touch part.

Therefore, the cosmetic vessel having an exchangeable touch part can prevent cosmetics from being stuck to a user's hand. In addition, the touch part includes at least one through-hole having various shapes to evenly discharge content onto the touch part. Further, the touch part can be formed of various materials to evenly spread the content and improve touch feeling.

### TECHNICAL FIELD

The present invention relates to a cosmetic vessel for containing content such as liquid foundation, sun block lotion in a gel state, and other content that can be rubbed on a user's skin (hereinafter, referred to as “liquid-type content”), and more particularly, to a cosmetic vessel having an exchangeable touch part in contact with a user's skin.

### BACKGROUND ART

In general, a conventional cosmetic vessel for containing liquid-type content has no separate touch part. Therefore, a user has to discharge the content on to his/her hands or cheeks and rub the content to evenly spread the cosmetic content. In this case, a user's hand may be sticky, and the cosmetic content may not be evenly spread.

### DISCLOSURE

### Technical Problem

In order to solve the problem, the present invention provides a cosmetic vessel having an exchangeable touch part capable of preventing cosmetic from being stuck to a user's hand by providing a touch part.

The present invention also provides a cosmetic vessel having an exchangeable touch part capable of readily exchanging the touch part after using the touch part certain times.

The present invention also provides a cosmetic vessel having an exchangeable touch part capable of evenly discharging content through the entire touch part, evenly spreading the content onto a user's skin, and providing soft touch.

### Technical Solution

The present invention relates to a cosmetic vessel having an exchangeable touch part, and more particularly, to a cosmetic vessel using content such as liquid foundation, sun block lotion similar to a gel state, and other content that can be rubbed on a user's skin (hereinafter, referred to as “liquid-type content”).

According to an aspect of the present invention, a cosmetic vessel having an exchangeable touch part includes an accommodating part having an opening formed at one side thereof and containing liquid content; a discharge part coupled with an opening of the accommodating part and having at least one discharge projection formed at its one side to discharge the content therethrough; a touch part having a through-hole through which the discharge projection of the discharge part is inserted; and a cover part surrounding the touch part.

Here, a mounting projection may be formed at an inner surface of the discharge part and an insert groove may be formed at an outer surface of the touch part to be coupled with the mounting projection, or an insert groove may be formed at an inner surface of the discharge part and a mounting projection may be formed at an outer surface of the touch part to be coupled with the insert groove.

According to another aspect of the present invention, a a cosmetic vessel having an exchangeable touch part includes an accommodating part having an opening formed at one side thereof and containing liquid content; a discharge part coupled with an opening of the accommodating part and having at least one discharge projection formed at its one side to discharge the content therethrough; a support part coupled with the discharge part and accommodating the touch part; a touch part having a through-hole through which the discharge projection of the discharge part is inserted, and accommodated in the support part; and a cover part surrounding the touch part.

Here, a mounting projection may be formed at an inner surface of the support part and an insert groove may be formed at an outer surface of the touch part to be coupled with the mounting projection, or an insert groove may be formed at an inner surface of the support part and a mounting projection may be formed at an outer surface of the touch part to be coupled with the insert groove.

### DESCRIPTION OF DRAWINGS

The above and other features of the present invention will be described in reference to certain exemplary embodiments thereof with reference to the attached drawings in which:

FIG. 1 is an exploded cross-sectional view of a cosmetic vessel in accordance with the present invention, before assembling the cosmetic vessel;

FIG. 2 is a cross-sectional view of a touch part of a cosmetic vessel in accordance with an exemplary embodiment of the present invention;

FIG. 3 is a cross-sectional view of a touch part of a cosmetic vessel in accordance with another exemplary embodiment of the present invention;

FIG. 4 is a plan view of various embodiments of a through-hole of a touch part in accordance with the present invention;

FIG. 5 is a cross-sectional view of various embodiments of a material of a touch part in accordance with the present invention;

FIG. 6 is a cross-sectional view of a discharge part in accordance with the present invention, further including a packing; and

FIG. 7 is a cross-sectional view of a cosmetic vessel of FIG. 1, after assembling the cosmetic vessel.

* Description of Major Reference Numerals *

| | |
|---|---|
| 100: Accommodating part | 110: Opening |
| 200: Discharge part | 210: Discharge projection |
| 230: Mounting projection | 250: Mounting groove |
| 270: Packing | 300: Support part |
| 310: Mounting projection | 330: Mounting groove |
| 400: Touch part | 410: Through-hole |
| 430: Insert groove | 450: Insert projection |
| 500: Cover part | 510: Discharge projection cap |
| 530: Mirror | 600: Brush |

### MODES OF THE INVENTION

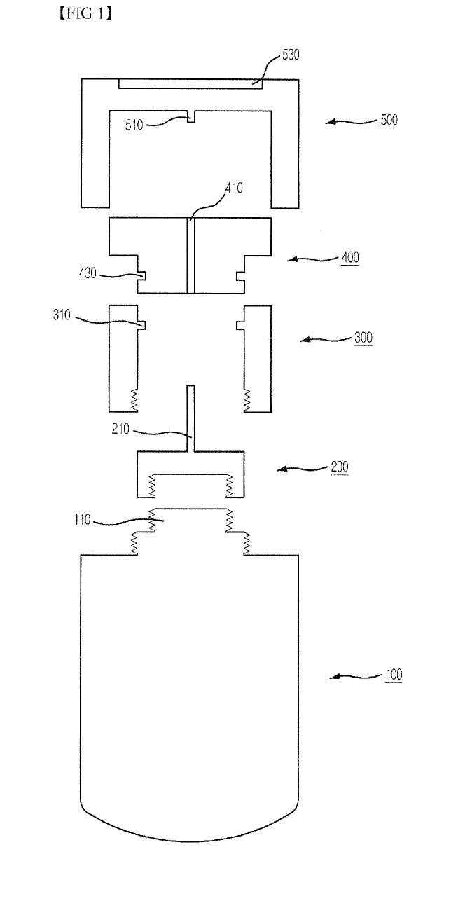

The present invention will now be described more fully hereinafter with reference to the accompanying drawings, in which exemplary embodiments of the invention are shown. FIG. 1 is an exploded cross-sectional view of a cosmetic vessel in accordance with the present invention, before assembling the cosmetic vessel. The cosmetic vessel in accordance with an exemplary embodiment of the present invention shown in FIG. 1 includes an accommodating part 100, a discharge part 200, a support part 300, a touch part 400, and a cover part 500.

The accommodating part 100 may have an opening 110, and may contain liquid-type content.

The discharge part 200 has a discharge projection 210 having an inner hole. The discharge part 200 is coupled with the opening 110 of the accommodating part 100 through various ways such as a screw coupling shown in FIG. 1, a snap coupling, or the like. In addition, the accommodating part 100 and the discharge part 200 in accordance with the present invention may be integrally formed with each other.

The support part 300 may have a mounting projection 310 for mounting the touch part 400. The mounting projection 310 is inserted into an insert groove 430 to of the touch part 400 to couple the support part 300 with the touch part 400. In addition, when the support part 300 is coupled with the accommodating part 100 and/or the discharge part 200, a lower portion of the touch part 400 under the insert groove 430 is pressed to more securely couple the support part 300 with the touch part 400.

The touch part 400 has a through-hole 410 such that the discharge projection 210 of the discharge part 200 is inserted into the through-hole 410 when the discharge part 200 is coupled with the touch part 400.

The cover part 500 includes a discharge projection cover 510 and a mirror 530. The discharge projection cover 510 is formed at an inner upper surface of the cover part 500 and slightly inserted into an upper part of the through-hole 410 of the touch part 400 to prevent discharge of liquid-type content from the discharge projection 210 of the discharge part. Therefore, though the discharge projection 210 of the discharge part 200 may have the same height as an upper surface of the touch part 400, and preferably, may have a height lower than the height of the upper surface of the touch part 400. This is because a user's skin may be scratched due to direct contact of the discharge projection 210 with the skin when the cosmetic vessel in accordance with the present invention is touched to the skin.

A mirror 530 may be installed at an outer surface of the cover 500. In FIG. 1, while the mirror 530 is installed at an outer upper surface of the cover 500, the mirror 530 may be installed at a side surface thereof.

In the case of the embodiment shown in FIG. 1, a user may exchange the touch part 400 only, or exchange the support part 300 and the touch part 400 coupled with each other.

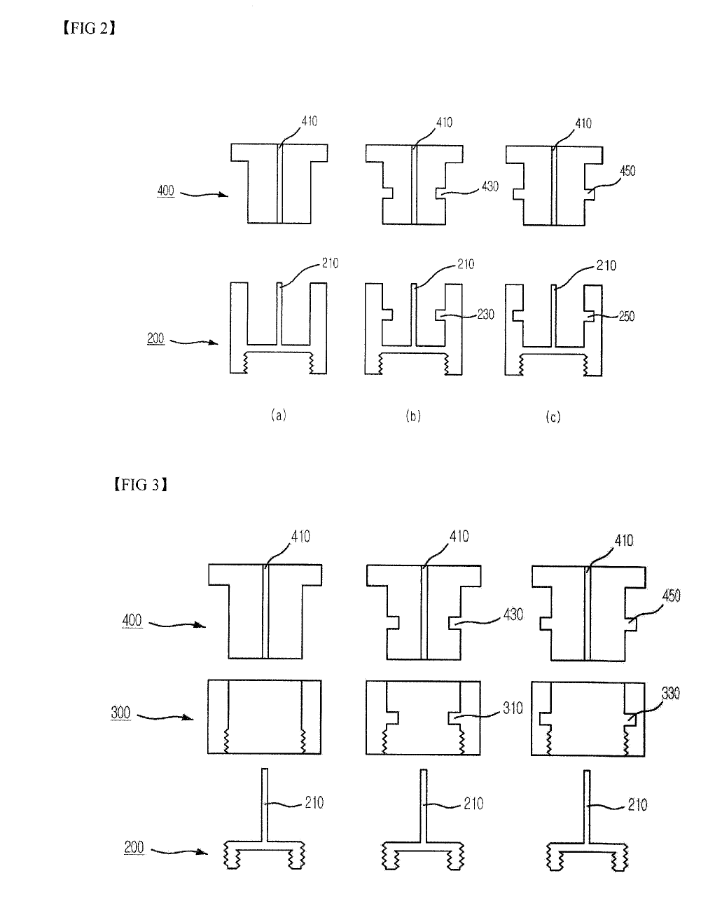

FIG. 2 is a cross-sectional view of a touch part of a cosmetic vessel in accordance with an exemplary embodiment of the present invention. Here, the touch part 400 may have an outer diameter substantially equal to an inner diameter of the discharge part 200 to enable a smooth fitting therebetween, or has an outer diameter slightly larger than an inner diameter of the discharge part 200 to enable a press fitting therebetween (see FIG. 2(a)).

In addition, the discharge part 200 may have a mounting projection 230, and the touch part 400 may have an insert groove 430 corresponding to the mounting projection to insert the projection 230 into the groove 430 (see FIG. 2(b)). Or, the discharge part 200 may have a mounting groove 250, and the touch part 400 may have an insert projection 450 corresponding to the mounting groove 250 to insert the projection 450 into the groove 250.

In the case of the embodiment shown in FIG. 2, a user may exchange the touch part 400 only, or may exchange the discharge part 200 and the touch part 400 coupled with each other.

FIG. 3 is a cross-sectional view of a touch part of a cosmetic vessel in accordance with another exemplary embodiment of the present invention shown in FIG. 1. In this embodiment, a press fitting between a discharge part 400 and a support part 300 (see FIG. 3(a)) and an insert coupling using an insert groove and a mounting projection (see FIGS. 3(b) and 3(c)) are the same as FIGS. 2(a), 2(b) and 2(c).

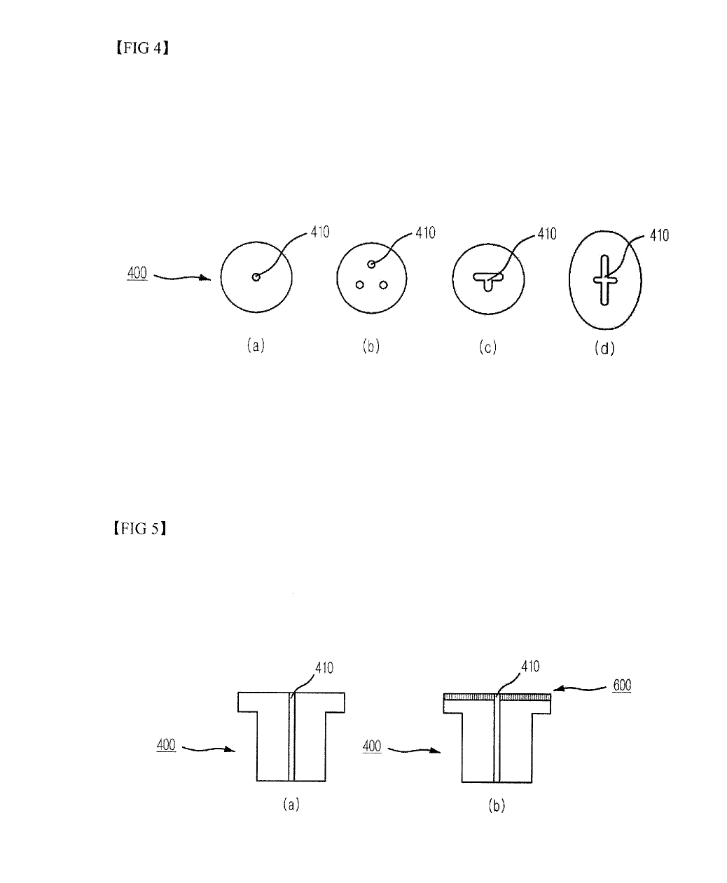

FIG. 4 is a plan view of various embodiments of a through-hole of a touch part in accordance with the present invention. At least one discharge projections 210 may be formed at a discharge part 200, and at least one through-hole 410 corresponding to the above at least one discharge projections 210 may be formed at the touch part 400 to insert the discharge projection 210 into the through-hole 410 (FIGS. 4(a) and 4(b)).

In addition, the discharge projection 210 may have various shapes, and the through-hole 410 may also have various shapes corresponding to thereto. Meanwhile, though the discharge projection 210 may have a circular shape, the through-hole 410 may have various shapes such as a T shape (see FIG. 4(c)), or a cross shape (FIG. 4(d)).

The touch part 400 may also have various shapes. For example, in the case of an elongated oval shape, the through-hole 410 may have a vertically extended cross shape (see FIG. 4(d)) to rapidly and evenly apply liquid-type content on a surface of the touch part 400.

Meanwhile, the cosmetic vessel in accordance with the present invention may contain liquid-type content having various properties. In addition, since oil may be contained depending on characteristics of cosmetics, the touch part 400 in accordance with the present invention may be formed of an oil-resistance material into which little oil is absorbed.

Further, the touch part 400 in accordance with the present invention may have a certain level of elasticity to evenly spread the liquid-type content on a user's skin in contact with the touch part 400. Therefore, the touch part in accordance with the present invention may be formed of any one selected from the group consisting of polyurethane, silicon, and foam rubber. Furthermore, the foam rubber may be formed of nitrile butadiene rubber (NBR) having good oil resistance, wearing resistance, and durability.

FIG. 5 is a cross-sectional view of various embodiments of a material of a touch part in accordance with the present invention. The touch part 400 in accordance with the present invention may be formed of a single material (see FIG. 5(a)), or may further include a brush part 600 attached on an upper surface of the touch part 400 (see FIG. 5(b)).

The brush part 600 in accordance with the present invention functions to improve touch feeling and evenly spread the liquid-type content. The brush part is 600 in accordance with the present invention may be formed of nylon pile.

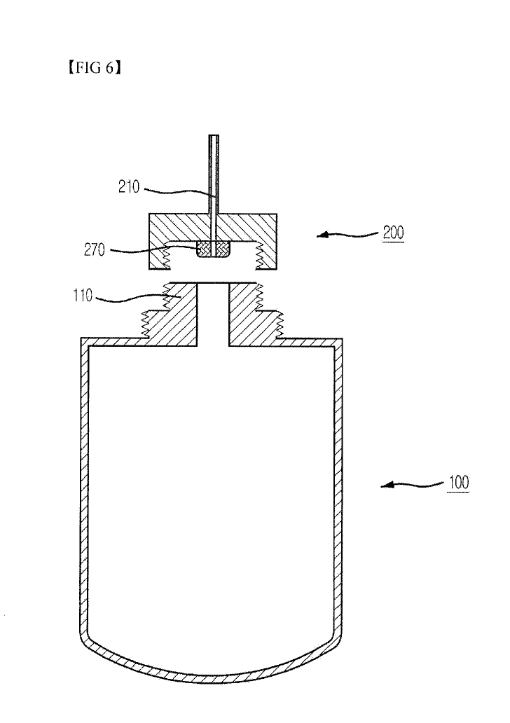

FIG. 6 is a cross-sectional view of a discharge part 20 in accordance with the present invention, further including a packing 270. In order to prevent leakage of the liquid-type content contained in the cosmetic vessel in accordance with the present invention, as shown in FIG. 6, the discharge part 200 further includes the packing 270 disposed therein and having through hole which is in communication with the inner hole of the discharge projection 210, and the opening 110 of the accommodating part 100 has a shaped corresponding to the packing 270, thereby forming a sealing by packing 270 between the accommodating part 100 and the discharge part 200. The packing 270 may be formed of a general material capable of preventing leakage of water or oil. In addition, the discharge part 200 and the packing 270 may be formed of different materials or the same material.

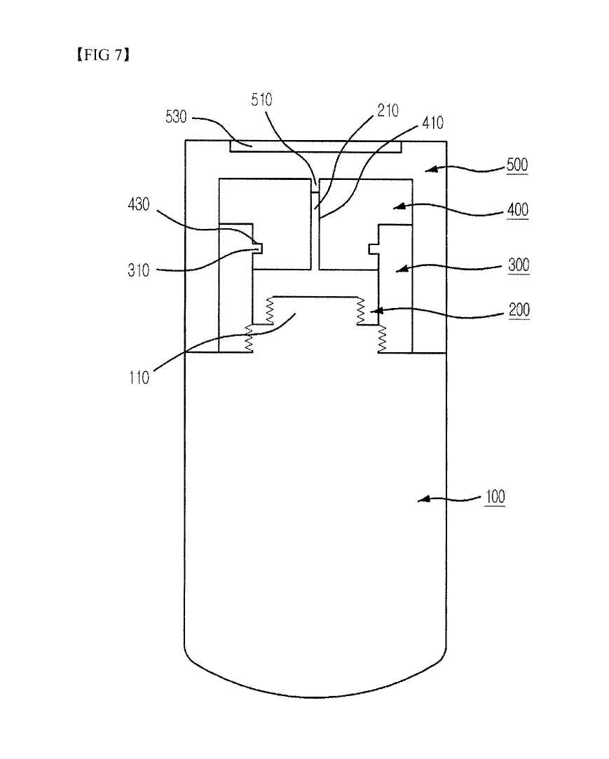

FIG. 7 is a cross-sectional view of a cosmetic vessel of FIG. 1, after assembling the cosmetic vessel. While FIGS. 1 and 7 illustrate the embodiments in which the support part 300 is coupled with the discharge part 200, the support part 300 may also be coupled with the accommodating part 100. In addition, while the touch part 400 of FIGS. 1 and 7 has an upper part larger than a lower part, the upper part may be equal to the lower part.

### INDUSTRIAL APPLICABILITY

As can be seen from the foregoing, a cosmetic vessel in accordance with the present invention includes an exchangeable touch part to prevent cosmetics from being stuck to a user's hand.

In addition, the touch part includes at least one through-hole having various shapes to evenly discharge content onto the touch part.

Further, the touch part can be formed of various materials to evenly spread the content and improve touch feeling.

1. A cosmetic vessel having an exchangeable touch part comprising:
an accommodating part having an opening formed at one side thereof and containing liquid content;
a discharge part coupled with an opening of the accommodating part and having at least one discharge projection formed at its one side to discharge the content therethrough;
a touch part having a through-hole through which the discharge projection of the discharge part is inserted; and
a cover part surrounding the touch part.

2. The cosmetic vessel having an exchangeable touch part according to claim 1, wherein a mounting projection is formed at an inner surface of the discharge part and an insert groove is formed at an outer surface of the touch part to be coupled with the mounting projection, or
an insert groove is formed at an inner surface of the discharge part and a mounting projection is formed at an outer surface of the touch part to be coupled with the insert groove.

3. A cosmetic vessel having an exchangeable touch part comprising:
an accommodating part having an opening formed at one side thereof and containing liquid content;
a discharge part coupled with an opening of the accommodating part and having at least one discharge projection formed at its one side to discharge the content therethrough;
a support part coupled with the discharge part and accommodating the touch part;
a touch part having a through-hole through which the discharge projection of the discharge part is inserted, and accommodated in the support part; and
a cover part surrounding the touch part.

4. The cosmetic vessel having an exchangeable touch part according to claim 3, wherein a mounting projection is formed at an inner surface of the support part and an insert groove is formed at an outer surface of the touch part to be coupled with the mounting projection, or
an insert groove is formed at an inner surface of the support part and a mounting projection is formed at an outer surface of the touch part to be coupled with the insert groove.

5. The cosmetic vessel having an exchangeable touch part according to claim 1, wherein the touch part is formed of an oil-resistance material.

6. The cosmetic vessel having an exchangeable touch part according to claim 2, wherein the touch part is formed of an oil-resistance material.

7. The cosmetic vessel having an exchangeable touch part according to claim 3, wherein the touch part is formed of an oil-resistance material.

8. The cosmetic vessel having an exchangeable touch part according to claim 4, wherein the touch part is formed of an oil-resistance material.

9. The cosmetic vessel having an exchangeable touch part according to claim 1, wherein the touch part is formed of any one selected from the group consisting of polyurethane, silicon, and foam rubber.

10. The cosmetic vessel having an exchangeable touch part according to claim 2, wherein the touch part is formed of any one selected from the group consisting of polyurethane, silicon, and foam rubber.

11. The cosmetic vessel having an exchangeable touch part according to claim 3, wherein the touch part is formed of any one selected from the group consisting of polyurethane, silicon, and foam rubber.

12. The cosmetic vessel having an exchangeable touch part according to claim 4, wherein the touch part is formed of any one selected from the group consisting of polyurethane, silicon, and foam rubber.

13. The cosmetic vessel having an exchangeable touch part according to claim 9, wherein the foam rubber is nitrile butadiene rubber.

14. The cosmetic vessel having an exchangeable touch part according to claim 10, wherein the foam rubber is nitrile butadiene rubber.

15. The cosmetic vessel having an exchangeable touch part according to claim 11, wherein the foam rubber is nitrile butadiene rubber.

16. The cosmetic vessel having an exchangeable touch part according to claim 12, wherein the foam rubber is nitrile butadiene rubber.

17. The cosmetic vessel having an exchangeable touch part according to claim 1, wherein the touch part further comprises a brush part disposed on an upper surface thereof.

18. The cosmetic vessel having an exchangeable touch part according to claim 2, wherein the touch part further comprises a brush part disposed on an upper surface thereof.

19. The cosmetic vessel having an exchangeable touch part according to claim 3, wherein the touch part further comprises a brush part disposed on an upper surface thereof.

20. The cosmetic vessel having an exchangeable touch part according to claim 4, wherein the touch part further comprises a brush part disposed on an upper surface thereof.

21. The cosmetic vessel having an exchangeable touch part according to claim 17, wherein the brush part is nylon pile.

22. The cosmetic vessel having an exchangeable touch part according to claim 18, wherein the brush part is nylon pile.

23. The cosmetic vessel having an exchangeable touch part according to claim 19, wherein the brush part is nylon pile.

24. The cosmetic vessel having an exchangeable touch part according to claim 20, wherein the brush part is nylon pile.

25. The cosmetic vessel having an exchangeable touch part according to claim 1, wherein the cover part further comprises a discharge projection cap for blocking the discharge projection of the discharge part.

26. The cosmetic vessel having an exchangeable touch part according to claim 2, wherein the cover part further comprises a discharge projection cap for blocking the discharge projection of the discharge part.

27. The cosmetic vessel having an exchangeable touch part according to claim 3, wherein the cover part further comprises a discharge projection cap for blocking the discharge projection of the discharge part.

28. The cosmetic vessel having an exchangeable touch part according to claim 4, wherein the cover part further comprises a discharge projection cap for blocking the discharge projection of the discharge part.

29. The cosmetic vessel having an exchangeable touch part according to claim 1, wherein the cover part further comprises a mirror disposed on an outer surface thereof.

30. The cosmetic vessel having an exchangeable touch part according to claim 2, wherein the cover part further comprises a mirror disposed on an outer surface thereof.

31. The cosmetic vessel having an exchangeable touch part according to claim 3, wherein the cover part further comprises a mirror disposed on an outer surface thereof.

32. The cosmetic vessel having an exchangeable touch part according to claim 4, wherein the cover part further comprises a mirror disposed on an outer surface thereof.

33. The cosmetic vessel having an exchangeable touch part according to claim 1, wherein the discharge part further comprises a packing disposed therein and in communication with the discharge projection, and the opening of the accommodating part has a shape corresponding to the packing to form a sealing by packing between the accommodating part and the discharge part.

34. The cosmetic vessel having an exchangeable touch part according to claim 2, wherein the discharge part further comprises a packing disposed therein and in communication with the discharge projection, and the opening of the accommodating part has a shape corresponding to the packing to form a sealing by packing between the accommodating part and the discharge part.

35. The cosmetic vessel having an exchangeable touch part according to claim 3, wherein the discharge part further comprises a packing disposed therein and in communication with the discharge projection, and the opening of the accommodating part has a shape corresponding to the packing to form a sealing by packing between the accommodating part and the discharge part.

36. The cosmetic vessel having an exchangeable touch part according to claim 4, wherein the discharge part further comprises a packing disposed therein and in communication with the discharge projection, and the opening of the accommodating part has a shape corresponding to the packing to form a sealing by packing between the accommodating part and the discharge part.
